(19) United States
(12) Patent Application Publication
(10) Pub. No.: US 2020/0207982 A1
(43) Pub. Date: Jul. 2, 2020

(54) POLYAMIDE BLENDS

(71) Applicant: DOW SILICONES CORPORATION, Midland, MI (US)

(72) Inventors: Thomas CHAUSSEE, Midland, MI (US); Damien DEHEUNYNCK, Midland, MI (US); Michal HREBICIK, Midland, MI (US); Vincent RERAT, Midland, MI (US); Fabien RIALLAND, Midland, MI (US)

(21) Appl. No.: 16/632,357

(22) PCT Filed: Jun. 20, 2018
(86) PCT No.: PCT/US2018/038395

§ 371 Date: Jan. 19, 2020

(30) Foreign Application Priority Data
Jul. 20, 2017 (GB) 1711712.8

(51) Int. Cl. C08L 77/02; C08J 3/20

(52) U.S. Cl. CPC C08L 77/02; C08J 2451/06; C08J 2377/02; C08J 3/203

(57) ABSTRACT

A polyamide blend includes a polyamide polymer, a glass based reinforcing filler, and a hydrolysable silane grafted polypropylene. The polyamide blend is useful in appliances, consumer products, electronics, machine components, and automotive parts.

### CROSS REFERENCE TO RELATED APPLICATIONS

This application claims the benefit of GB Patent Application No. 1711712.8 filed 20 Jul. 2017 under 35 U.S.C. § 119 (a)-(d). GB Patent Application No. 1711712.8 is hereby incorporated by reference.

### TECHNICAL FIELD

The present invention relates generally to blends of filled polyamide based polymers with silane grafted polypropylene, as well as to a process for producing same.

### BACKGROUND

Polyamides (PAs) are produced either by the reaction of a diacid with a diamine or by ring-opening polymerization of lactams. Aliphatic polyamides are largely amorphous, i.e. only moderately crystalline. They include nylon materials including, for the sake of example, nylon 3 (poly(propiolactam)), nylon 6 (poly(caprolactam)), nylon 8 (polycapryllactam), nylon 10, (poly(decano-10-lactam)), nylon 11 (poly(w-undecanamide)), nylon 12-poly(w-dodecanamide, nylon 6,6, poly(hexamethylene adipamide), nylon 6, 10 (polyhexamethylene sebacamide) and nylon 6,12 (polyhexamethylene dodecanediamide), of these nylon 6 and nylon 6,6 are probably the most important.

Nylons, not least nylon 6 and nylon 6,6 have excellent mechanical properties including high tensile strength, high flexibility, good resilience, low creep and high impact strength (toughness) and exhibit excellent resistance to wear due to a low coefficient of friction (self-lubricating). Nylon 6 and nylon 6,6 both have high melting temperatures (225° C.-270° C.) and glass transition temperatures resulting in good mechanical properties at elevated temperatures. For example, the heat deflection temperature (HDT) of PA-6,6 is typically between 180 and 240° C. which exceeds those of polycarbonate and polyester. They also have good resistance to oils, bases, fungi, and many solvents. However, they have several limitations, not least a relatively low impact strength and strong moisture sensitivity, resulting in changes of mechanical properties. Moisture uptake continues until an equilibrium is reached and can have a negative effect on dimensional stability with, typically, the impact resistance and flexibility of nylon tending to increase with moisture content, while the strength and stiffness below the glass transition temperature (<50-80° C.) decreases.

It has been identified that the physical properties of polyamides can be varied by blending the polyamides with a variety of additives, particularly reinforcing fillers, especially reinforcing fibre fillers such as carbon fibres, aramid fibres and in particular glass fibres. Fibre reinforced composites especially glass fibre reinforced composites are known to provide significant increases in strength, stiffness, heat distortion temperatures, abrasion resistance and dimensional stability in nylons.

However, introduction of reinforcing fillers does not overcome the limitations caused by the propensity for moisture absorbance as glass fibre reinforced composites also lose mechanical properties when exposed to hydrolysis conditions.

Glass fibre reinforced polyamides are suitable for use in several applications e.g. within the automotive industry. However, whilst it would be advantageous to replace some metal parts in e.g. the automotive industry with glass fibre reinforced polyamide based materials this has not yet proven possible because of limitations on their use due to the negative impact on their physical properties caused by absorption of water/moisture in polyamides and/or polyamide blends. Hence there is a long term need to identify a satisfactory and cost-effective means for reducing the negative impact caused by water/moisture absorption in polyam ides and blends thereof.

### SUMMARY

There is provided herein a polyamide blend having improved resistance to moisture absorption comprising:
(1) a polyamide polymer,
(2) a glass based reinforcing filler, and
(3) a hydrolysable silane grafted polypropylene.

### DETAILED DESCRIPTION

In one embodiment there is provided herein a polyamide blend having improved resistance to moisture absorption consisting of:
(1) a polyamide polymer,
(2) a glass based reinforcing filler, and
(3) a hydrolysable silane grafted polypropylene.

### Polyamide Polymer (1)

Polyamide polymer (1) may be of the type formed by the reaction of a diamine having from 1-20 carbon atoms with an aliphatic or aromatic polycarboxylic acid having from 2-20 carbon atoms or by the or by ring-opening polymerization of lactams. A wide variety of diamines can be utilized in forming the polyamide, including aliphatic and aromatic diamines, and most preferably the alkylene diamines. Suitable diamines include dimethylene amine, trimethylene amine, tetramethylene diamine, hexamethylene diamine and the like. Suitable polycarboxylic acids include malonic acid, succinic acid, glutaric acid, adipic acid, pimelic acid, suberic acid, azelaic acid, maleic acid, glutaconic acid, phthalic acid, and the like with respective anhydrides or acid halides also being an option.

Examples of suitable polyamides which may be utilised as polyamide polymer (1) include nylon 3, nylon 6, nylon 7, nylon 8, nylon 9, nylon 10, nylon 11, nylon 12, nylon 6,6, nylon 6, 10 and nylon 6,12. Alternatively polyamide polymer (1) may be nylon 6 or nylon 6,6.

Polyamide (1) is present in the blend in an amount of from 1 wt. % to 98 wt. % alternatively from 25 wt % to 75 wt %.

### Glass Based Reinforcing Filler (2)

Any suitable glass based filler may be utilized as glass based reinforcing filler (2). In one embodiment the glass based reinforcing filler (2) may be cut or short glass fibre fillers having a length in the range of 0.1 to 1 mm, long fibres having a length of 1 to 50 mm or continuous fibres having a length>50 mm. Alternatively glass based reinforcing filler (2) may be short glass fibre fillers or long fibre fillers and have a length of between 0.1 and 20 mm. These values may be determined by microscopic analysis of individual glass fibres. The fibres may be of any suitable diameter e.g. from 5 to 40 μm, alternatively from 5 to 25 μm.

The glass based reinforcing filler (2) may be made from any suitable type of glass, such as “E glass (electro-glass, H glass (hollow fibres), R,S glass for high mechanical applications, D glass (borosilicate glass) and quartz glass for high thermal stability applications.

The term “glass fibres,” as used herein, refers to:
(1) continuous fibres formed by the rapid attenuation of hundreds of streams of molten glass and to strands formed when such continuous glass fibre filaments are gathered together in forming; and to yarns and cords formed by plying and/or twisting a number of strands together, and to woven and non-woven fabrics which are formed of such glass fibre strands, yarns or cords,
(2) discontinuous fibres formed by high pressure steam or air directed angularly downwardly onto multiple streams of molten glass issuing from the bottom side of glass melting bushing and to yarns that are formed when such discontinuous fibres are allowed to rain down gravitationally onto a foraminous surface wherein the fibres are gathered together to form a sliver which is drafted into a yarn; and to woven and non-woven fabrics formed of such yarns of discontinuous fibres; and
(3) combinations of such continuous and discontinuous fibres in strand, yarn, cord and fabrics formed thereof.

The glass based reinforcing filler (2) is present in an amount of from 0.1 wt. % to 50 wt. % of the polyamide blend, alternatively from 15 wt. % to 40 wt. % of glass based reinforcing filler.

### Hydrolysable Silane Drafted Polypropylene (3)

The hydrolysable silane grafted polypropylene may be any suitable silane grafted polypropylene. The polypropylene which is grafted may be any suitable polypropylene or may be a copolymer of polypropylene and polymers of other olefins such as butene or 2-methyl-propene-1 (isobutylene), hexene, heptene, octene, styrene. Polypropylene is a commodity polymer which is broadly available and of low cost. It has low density and is easily processed and versatile. Most commercially available polypropylene is isotactic polypropylene, but the process of the invention is applicable to atactic and syndiotactic polypropylene as well as to isotactic polypropylene. The polypropylene can alternatively be a polymer of a diene, such as a diene having 4 to 18 carbon atoms and at least one terminal double bond, for example butadiene or isoprene. The polypropylene can be a copolymer or terpolymer, for example a copolymer of propylene with ethylene or a copolymer of propylene or ethylene with an alpha-olefin having 4 to 18 carbon atoms, or of propylene with an acrylic monomer such as acrylic acid, methacrylic acid, acrylonitrile, methacrylonitrile or an ester of acrylic or methacrylic acid and an alkyl or substituted alkyl group. Polypropylene undergoes polymer degradation by chain β-scission when free radical sites are generated in the polypropylene, hence the following preferred process for making hydrolysable silane grafted polypropylenes (HSgPP) is particularly useful for making hydrolysable silane grafted polypropylene (3) as it achieves the required grafting while inhibiting chain β-scission degradation of the polypropylene.

Hydrolysable silane grafted polypropylene (1) may be present in the polyamide blend in an amount of from 1 wt. % to 99 wt. %, alternatively 1 wt. % to 98 wt. %, alternatively from 5 wt. % to 35 wt. % of hydrolysable silane grafted polypropylene.

The hydrolysable silane grafted polypropylene (3) may be a reaction product of hydrolysable silane with a polypropylene as described above. In one embodiment the silane may be either:
(1) a silane, having at least one hydrolysable group bonded to Si, or a hydrolysate thereof, and which has the formula R″—CH═CH—Z (I) or R″—C≡C—Z (II) in which Z represents an electron-withdrawing moiety substituted by a —SiRₐR′₃₋ₐ group wherein R represents a hydrolysable group; R′ represents a hydrocarbyl group having 1 to 6 carbon atoms; a has a value in the range 1 to 3 inclusive; and R″ represents hydrogen or a group having an electron withdrawing effect or any other activation effect with respect to the —CH═CH— or —C≡C— bond; or
(2) an unsaturated silane, containing an olefinic —C═C— bond or acetylenic —C≡C— bond and having at least one hydrolysable group bonded to Si, which silane contains an aromatic ring or a further olefinic double bond or acetylenic unsaturation, the aromatic ring or the further olefinic double bond or acetylenic unsaturation being conjugated with the olefinic —C═C— or acetylenic —C═C— unsaturation of the silane.

### Silane 1

Silane 1 is an unsaturated silane of the formula R″—CH═CH—Z (I) or R″—C≡C—Z (II) containing an electron withdrawing moiety Z which when carrying out the grafting reaction on the polypropylene gives an enhanced grafting yield compared to grafting with an olefinically unsaturated silane such as vinyltrimethoxysilane not containing the an electron withdrawing moiety Z. An electron-withdrawing moiety is a chemical group which draws electrons away from a reaction center. The electron-withdrawing moiety Z may be a C(═O)R*, C(═O)OR*, OC(═O)R*, C(═O)Ar moiety in which Ar represents arylene substituted by a —SiRₐR′₍₃₋ₐ₎ group and R* represents a hydrocarbon moiety substituted by a —SiRₐR′₍₃₋ₐ₎ group. Z can also be a C(═O)—NH—R* moiety. Preferred silanes include:

R″—CH═CH—X—Y—SiRₐR′₍₃₋ₐ₎ (III) or

R″—C≡C—X—Y—SiRₐR′₍₃₋ₐ₎ (IV)

in which X represents a chemical linkage having an electron withdrawing effect with respect to the —CH═CH— or a —C≡C— bond such as a carboxyl, carbonyl, or amide linkage, and Y represents a divalent organic spacer linkage comprising at least one carbon atom separating the linkage X from the Si atom.

When the unsaturated silane contains a —CH═CH— bond, the grafted polypropylene is characterized in that the polypropylene contains grafted moieties of the formula R″—CH(PP)—CH₂—Z and/or grafted moieties of the formula R″—CH₂—CH(PP)—Z wherein Z represents an electron-withdrawing moiety substituted by a —SiRₐR′₍₃₋ₐ₎group wherein R represents a hydrolysable group; R′ represents a hydrocarbyl group having 1 to 6 carbon atoms; a has a value in the range 1 to 3 inclusive; R″ represents hydrogen or a group having an electron withdrawing effect; and PP represents a polypropylene chain in which less than 50% by weight of the total units in the polypropylene are ethylene units.

Each hydrolysable group R in the —SiRₐR′₍₃₋ₐ₎ group of the unsaturated silane (1) of the formula R″—CH═CH—Z (I) or R″—C≡C—Z (II) is preferably an alkoxy group, although alternative hydrolysable groups such as acyloxy, for example acetoxy, ketoxime, for example methylethylketoxime, alkyllactato, for example ethyllactato, amino, amido, aminoxy or alkenyloxy groups can be used. Alkoxy groups R generally each have a linear or branched alkyl chain of 1 to 6 carbon atoms and most preferably are methoxy or ethoxy groups. The value of a in the silane (I) or (II) can for example be 3, for example the silane can be a trimethoxy silane, to give the maximum number of hydrolysable and/or cross-linking sites. However each alkoxy group generates a volatile organic alcohol when it is hydrolysed, and it may be preferred that the value of a in the silane (I) or (II) is 2 or even 1 to minimize the volatile organic material emitted during cross-linking. The group R′ if present is preferably a methyl or ethyl group.

Unsaturated silane (1) can be partially hydrolysed and condensed into oligomers containing siloxane linkages. For most end uses it is preferred that such oligomers still contain at least one hydrolysable group bonded to Si per unsaturated silane monomer unit so that the grafted polymer has sufficient reactivity towards itself and towards polar surfaces and materials. If the grafted polymer is to be cross-linked in a second step, it is usually preferred that hydrolysis and condensation of the silane before grafting will be minimized.

In the unsaturated silane (1) of formula (III) or (IV) above the electron withdrawing linkage X is preferably a carboxyl linkage. Preferred silanes thus have the formula:

R″—CH═CH—C(═O)O—Y—SiRₐR′₍₃₋ₐ₎ (V) and

R″—C≡C—C(═O)O—Y—SiRₐR′₍₃₋ₐ₎ (VI).

The spacer linkage Y can in general be a divalent organic group comprising at least one carbon atom, for example an alkylene group such as methylene, ethylene or propylene, or an arylene group, or a polyether chain, e.g., polyethylene glycol or polypropylene glycol. When the group R″ represents hydrogen and Y is an alkylene linkage, the moiety R″—CH═CH—C(═O)O—Y— in the unsaturated silane (V) is an acryloxyalkyl group. We have found that acryloxyalkylsilanes graft to polypropylenes more readily than vinylsilanes, alkylsilanes or methacryloxyalkylsilanes. Examples of preferred acryloxyalkylsilanes are γ-acryloxypropyltrimethoxysilane, acryloxymethyltrimethoxysilane, acryloxymethylmethyldimethoxysilane, acryloxymethyldimethylmethoxysilane, γ-acryloxypropylmethyldimethoxysilane and γ-acryloxypropyldimethylmethoxysilane. γ-Acryloxypropyltrimethoxysilane.

In unsaturated silane (1) of formula (III) or (IV), the electron withdrawing linkage X can alternatively be a C(═O)—NH—Y—SiRₐR′₍₃₋ₐ₎ moiety. When the group R″ represents a carboxylic acid group, the unsaturated silane (III) is N-(trimethylsilylpropyl)maleamic acid.

The group R″ in the silane (1) of the formula (III) or (IV) above can alternatively be an alkenyl group, for example R″ can be a propenyl group, X a C(═O)O group and Y an alkylene group, with the silane being an alkoxysilylalkyl ester of acid.

The group R″ in the unsaturated silane (III) or (IV) can alternatively be an electron withdrawing group of the formula —X—Y—SiRₐR′₍₃₋ₐ₎, for example an electron withdrawing group where the linkage —X— is a carboxyl linkage. The unsaturated silane can thus be of the form RₐR′₍₃₋ₐ₎Si—Y—O(O═)C—CH═CH—C(═O)O—Y—Si RₐR′₍₃₋ₐ₎, or RₐR′₍₃₋ₐ₎Si—Y—O(O═)C—C≡C—C(═O)O—Y—Si RₐR′₍₃₋ₐ₎. The unsaturated silane (III) can comprise a bis(trialkoxysilylalkyl) fumarate (trans-isomer) and/or a bis(trialkoxysilylalkyl) maleate (cis-isomer). Examples are bis-(γ-trimethoxysilylpropyl) fumarate.

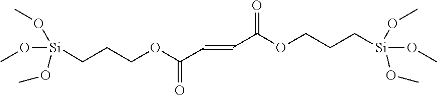

and bis-(γ-trimethoxysilylpropyl) maleate

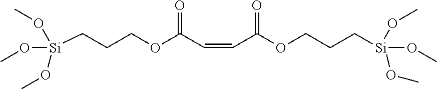

### Silane 2

Unsaturated silane (2), contains an olefinic —CH═CH— bond or acetylenic —C═C— bond and at least one hydrolysable group bonded to Si, or an hydrolysate thereof is characterized in that the silane contains an aromatic ring or a further olefinic double bond or acetylenic unsaturation, the aromatic ring or the further olefinic or acetylenic bond being conjugated with the olefinic —CH═CH— or acetylenic —C≡C— unsaturation of the silane.

By an aromatic ring we mean any cyclic moiety which is unsaturated and which shows some aromatic character or π-bonding. The aromatic ring can be a carbocyclic ring such as a benzene or cyclopentadiene ring or a heterocyclic ring such as a furan, thiophene, pyrrole or pyridine ring, and can be a single ring or a fused ring system such as a naphthalene, quinoline or indole moiety.

The hydrolysable group of the silane (2) preferably has the formula —SiRₐR′₍₃₋ₐ₎ wherein R R′, and a are as hereinbefore described. Each hydrolysable group R in the —SiRₐR′₍₃₋ₐ₎ group may be an alkoxy group, although alternative hydrolysable groups such as acyloxy, for example acetoxy, ketoxime, for example methylethylketoxime, alkyllactato, for example ethyllactato, amino, amido, aminoxy or alkenyloxy groups can be used. Alkoxy groups R generally each have a linear or branched alkyl chain of 1 to 6 carbon atoms and most preferably are methoxy or ethoxy groups. The value of a can for example be 3, for example the silane can be a trimethoxy silane, to give the maximum number of cross-linking sites. However each alkoxy group generates a volatile organic alcohol when it is hydrolysed, and it may be preferred that the value of a is 2 or even 1 to minimize the volatile organic material emitted during cross-linking. The group R′ if present is preferably a methyl or ethyl group.

Preferably, the unsaturated silane (2) contains an electron-withdrawing moiety with respect to the olefinic —C═C— or acetylenic —C≡C— bond. The moiety can be especially a C(═O)R*, C(═O)OR*, OC(═O)R*, C(═O)Ar in which Ar and R* as hereinbefore described. The electron withdrawing moiety can also be a C(═O)—NH—R* moiety.

Preferred silanes include those of the form

R″—CH═CH—X—Y—SiRₐR′₍₃₋ₐ₎ (III) or

R″—C≡C—X—Y—SiRₐR′₍₃₋ₐ₎ (IV)

as above, wherein X and Y are as hereinbefore described.

Electron-donating groups, for example alcohol groups or amino groups may decrease the electron withdrawing effect. In one embodiment, the unsaturated silane is free of such groups. Steric effects for example steric hindrance of a terminal alkyl group such as methyl, may affect the reactivity of the olefinic or acetylenic bond. In one embodiment, the unsaturated silane is free of such sterically hindering group. Groups enhancing the stability of the radical formed during the grafting reaction, for example double bond or aromatic group conjugated with the unsaturation of the silane, are present in the unsaturated silane. The latter groups have an activation effect with respect to the —CH═CH— or —C≡C— bond.

Unsaturated silane (2) can for example have the formula:

CH₂═CH—C₆H₄-A-SiRₐR′₍₃₋ₐ₎ (VI) or

CH≡C—C₆H₄-A-SiRₐR′₍₃₋ₐ₎ (VII),

wherein A represents a direct bond or a spacer group.

If A represents a direct bond in CH₂═CH—C₆H₄-A-SiRₐR′₍₃₋ₐ₎ (VI), the silane is trimethoxysilylstyrene, for example 4-(trimethoxysilyl)styrene.

If A represents a spacer group, it can be an organic group such as, for example, a divalent organic group comprising at least one carbon atom, for example an alkylene group such as methylene, ethylene or propylene, or an arylene group, or a polyether chain, e.g., polyethylene glycol or polypropylene glycol. A can be for example a linear or branched alkylene group having 1 to 4 carbon atoms, for example the silane can be 2-styryl-ethyltrimethoxysilane or 3-styryl-propyltrimethoxysilane.

Alternatively, the spacer group A can comprise a heteroatom linking group particularly an oxygen, sulfur or nitrogen heteroatom. Preferably the heteroatom linking group is selected from the group consisting of —O—, —S—, —NH—, with mercapto (—S—) group being preferred e.g. vinylphenylmethylthiopropyltrimethoxysilane.

We have found according to the invention that the use of unsaturated silane (2) of the formula (VI) or (VII) above in carrying out the grafting reaction on the polypropylene may provide an efficient grafting while preventing polymer degradation compared to grafting with an olefinically unsaturated silane such as vinyltrimethoxysilane not containing vinyl aromatic group. A more efficient grafting is also observed in comparison to vinyltrimethoxysilane+co-agent such as styrene. The enhanced grafting can lead to enhanced cross-linking of the polypropylene in a shorter time in the presence of moisture and possibly a silanol condensation catalyst.

The grafted polypropylene can for example contain moieties of the formula

PP—CH(CH₃)—C₆H₄-A-SiRₐR′₍₃₋ₐ₎

and/or grafted moieties of the formula

PP—CH₂—CH₂—C₆H₄-A-SiRₐR′₍₃₋ₐ₎

wherein A represents a direct bond or a divalent organic group having 1 to 12 carbon atoms; R represents a hydrolysable group; R′ represents a hydrocarbyl group having 1 to 6 carbon atoms; a has a value in the range 1 to 3 inclusive; and PP represents a polypropylene chain.

Unsaturated silane (2) can alternatively be of the formula

R″—CH═CH-A-SiRₐR′₍₃₋ₐ₎ (VIII),

R″—C≡C-A-SiRₐR′₍₃₋ₐ₎ (IX) or

R″—C(═CH₂)-A-SiRₐR′₍₃₋ₐ₎ (X),

where R″ represents a moiety containing an aromatic ring or a C═C bond conjugated with the C═C or C≡C and A represents a direct bond or a divalent organic linkage having 1 to 12 carbon atoms.

When R″ is an aromatic ring, the unsaturated silane can for example be cis/trans beta(trimethoxysilyl)styrene or alpha(trimethoxysilyl)styrene.

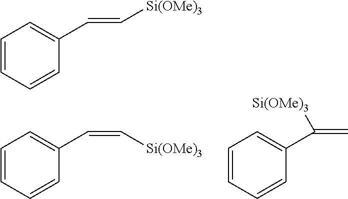

In one type of preferred unsaturated silane (2), A represents an organic linkage A′ having an electron withdrawing effect with respect to the —CH═CH— or —C≡C— bond. The electron withdrawing linkage may give enhanced grafting on the polypropylene compared to an olefinically unsaturated silane such as vinyltrimethoxysilane not containing an electron withdrawing moiety. An electron-withdrawing linkage is derived from an electron-withdrawing moiety. Preferred electron-withdrawing linkage are C(═O)O, OC(═O), C(═O) C(═O)—NH—.

The unsaturated silane (2) can alternatively be of the formula

R″′—CH═CH-A-SiRₐR′₍₃₋ₐ₎,

R″′—C≡C-A-SiRₐR′₍₃₋ₐ₎ (IV) or

R″—C(═CH₂)-A-SiRₐR′₍₃₋ₐ₎ (V),

where R″′ represents a moiety containing an aromatic ring or a C═C bond conjugated with the C═C or C≡C and A represents a direct bond or a divalent organic linkage having 1 to 12 carbon atoms.

A polypropylene grafted with hydrolysable silane groups can thus contain grafted moieties of the formula R″—CH(PP)—CH₂-A′-SiRₐR′₍₃₋ₐ₎ and/or grafted moieties of the formula R″—CH₂—CH(PP)-A′-SiRₐR′₍₃₋ₐ₎ wherein R represents a hydrolysable group; R′ represents a hydrocarbyl group having 1 to 6 carbon atoms; a has a value in the range 1 to 3 inclusive; A′ represents a chemical linkage having an electron withdrawing effect; R″ represents a group comprising an aromatic ring or a C═C bond; and PP represents a polypropylene chain.

In an unsaturated silane (2) of the formula R″—CH═CH—X—Y—SiRₐR′₍₃₋ₐ₎ (VI) or R″—C≡C—X—Y— SiRₐR′₍₃₋ₐ₎ (VII), the electron withdrawing linkage X is preferably a carboxyl linkage. Preferred silanes thus have the formula R″—CH═CH—C(═O)O—Y— SiRₐR₍₃₋ₐ₎ (VIII). When the group R″ represents phenyl, the moiety R″—CH═CH—C(═O)O—Y— in the unsaturated silane (VIII) is a cinnamyloxyalkyl group. The unsaturated silane (2) can for example be 3-cinnamyloxypropyltrimethoxysilane,

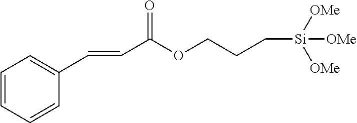 [SMILES: CO[Si](CCCOC(=O)/C=C/c1ccccc1)(OC)OC]

Preferably the group R″ can be a furyl group, for example a 2-furyl group, with the silane being an alkoxysilylalkyl ester of 3-(2-furyl)acrylic acid, i.e.,

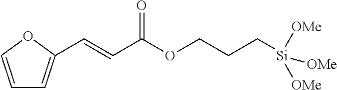 [SMILES: CO[Si](CCCOC(=O)/C=C/c1ccco1)(OC)OC]

Alternative preferred unsaturated silanes (2) have the formula R²—CH═CH—CH═CH—A′-SiRₐR′₍₃₋ₐ₎, where R² represents hydrogen or a hydrocarbyl group having 1 to 12 carbon atoms and A′ represents an organic linkage having an electron withdrawing effect with respect to the adjacent —CH═CH— bond. The linkage A′ can for example be a carbonyloxyalkyl linkage. The unsaturated silane can be a sorbyloxyalkylsilane such as 3-sorbyloxypropyltrimethoxysilane CH₃—CH═CH—CH═CH—C(═O)O—(CH₂)₃—Si(OCH₃)₃, i.e.,

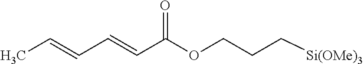

Other preferred unsaturated silanes (2) have the formula A″—CH═CH—CH=CH-A-SiRₐ R′₍₃₋ₐ₎ where A″ represents an organic moiety having an electron withdrawing effect with respect to the adjacent —CH═CH— bond, and A represents a direct bond or a divalent organic linkage having 1 to 12 carbon atoms.

The amount of silane (1) and/or unsaturated silane (2) present during the grafting reaction is generally at least 0.2% by weight based on the total composition and can be up to 20% or more. By total composition we mean the starting composition containing all ingredients, including polymer, silane, filler, catalyst etc. which are brought together to form the reacting mixture. Alternatively, the unsaturated silane is present at 0.5 to 20.0% by weight based on the total composition. Alternatively, the unsaturated silane is present at 0.5 to 15.0% by weight based on the total composition.

The compound capable of generating free radical sites in the polymer is preferably an organic peroxide, although other free radical initiators such as azo compounds can be used. Preferably the radical formed by the decomposition of the free-radical initiator is an oxygen-based free radical. It is more preferable to use hydroperoxides, carboxylic, peroxyketals, dialkyl peroxides and diacyl peroxides, ketone peroxides, diaryl peroxides, aryl-alky peroxides, peroxydicarbonates, peroxy acids, acylalkyl sulfinyl peroxide and alkyl monoperoxy dicarbonates. Examples of preferred peroxides include dicumyl peroxide, 2,5-dimethyl-2,5-di-(tert-butylperoxy)hexane, di-tert-butyl peroxide, 2,5-dimethyl-2,5-di-(tert-butylperoxy)hexyne-3,3,6,9-triethyl-3,6,9-trimethyl-1,4,7-triperoxonane, benzoyl peroxide, 2,4-dichlorobenzoyl peroxide, tert-butyl peroxyacetate, tert-butyl peroxybenzoate, tert-amylperoxy-2-ethylhexyl carbonate, tert-butylperoxy-3,5,5-trimethylhexanoate, 2,2-di(tert-butylperoxy)butane, tert-butylperoxy isopropyl carbonate, tert-buylperoxy-2-ethylhexyl carbonate, butyl 4,4-di(tert-buylperoxy)valerate, di-tert-amyl peroxide, tert-butyl peroxy pivalate, tert-butyl-peroxy-2-ethyl hexanoate, di(tertbutylperoxy) cyclohexane, tertbutylperoxy-3,5,5-trimethylhexanoate, di(tertbutylperoxyisopropyl) benzene, cumene hydroperoxide, tert-butyl peroctoate, methyl ethyl ketone peroxide, tert-butyl α-cumyl peroxide, 2,5-dimethyl-2,5-di(peroxybenzoate)hexyne-3, 1,3- or 1,4-bis(t-butylperoxyisopropyl)benzene, lauroyl peroxide, tert-butyl peracetate, and tert-butyl perbenzoate. Examples of azo compounds are azobisisobutyronitrile and dimethylazodiisobutyrate. The above radical initiators can be used alone or in a combination of at least two of them.

The compound capable of generating free radical sites in the polypropylene is generally present in an amount of at least 0.001% by weight based on the total composition and can be present in an amount of up to 5 or 10%. An organic peroxide, for example, is alternatively present at 0.01 to 2% by weight based on the total composition. Alternatively, the organic peroxide is present at 0.01% to 0.5% by weight based on the total composition.

The means for generating free radical sites in the polypropylene can alternatively be an electron beam. If electron beam is used, there is no need for a compound such as a peroxide capable of generating free radicals. The polypropylene is irradiated with an electron beam having an energy of at least 5 MeV in the presence of the unsaturated silane (I) or (II). Alternatively, the accelerating potential or energy of the electron beam is between 5 MeV and 100 MeV, more preferably from 10 to 25 MeV. The power of the electron beam generator is preferably from 50 to 500 kW, more preferably from 120 to 250 kW. The radiation dose to which the polypropylene/grafting agent mixture is subjected is alternatively from 0.5 to 10 Mrad. A mixture of polypropylene and silane (1) or unsaturated silane (2) can be deposited onto a continuously moving conveyor such as an endless belt, which passes under an electron beam generator, which irradiates the mixture. The conveyor speed is adjusted in order to achieve the desired irradiation dose.

Optionally, the grafting reaction of silane (1) and/or unsaturated silane (2) may take place in the presence of a co-agent. When present, said co-agent inhibits polymer degradation by beta scission. Many polymers of alpha-olefins having 3 or more carbon atoms, for example polypropylene, undergo polymer degradation by chain β-scission when free radical sites are generated in the polypropylene due to the presence of a tertiary carbon. Whilst for some uses, such as increasing the adhesion performances in coatings, such degradation may not be important, in most cases it will be desired to inhibit or even minimize polymer degradation by chain β-scission.

The co-agent which inhibits polymer degradation is preferably a compound containing an aromatic ring conjugated with an olefinic —C═C— or acetylenic —C≡C— unsaturated bond. By an aromatic ring we mean any cyclic moiety which is unsaturated and which shows some aromatic character or π-bonding. The aromatic ring can be a carbocyclic ring such as a benzene or cyclopentadiene ring or a heterocyclic ring such as a furan, thiophene, pyrrole or pyridine ring, and can be a single ring or a fused ring system such as a naphthalene, quinoline or indole moiety. Most preferably the co-agent is a vinyl or acetylenic aromatic compound such as styrene, alpha-methylstyrene, beta-methyl styrene, vinyltoluene, vinyl-pyridine, 2,4-biphenyl-4-methyl-1-pentene, phenylacetylene, 2,4-di(3-isopropylphenyI)-4-methyl-1-pentene, 2,4-di(4-isopropylphenyl)-4-methyl-1-pentene, 2,4-di(3-methylphenyI)-4-methyl-1-pentene, 2,4-di(4-methylphenyl)-4-methyl-1-pentene, and may contain more than one vinyl group, for example divinylbenzene, o-, m- or p-diisopropenylbenzene, 1,2,4- or 1,3,5-triisopropenylbenzene, 5-isopropyl-m-diisopropenylbenzene, 2-isopropyl-p-diisopropenylbenzene, and may contain more than one aromatic ring, for example trans- and cis-stilbene, 1,1-diphenylethylene, or 1,2-diphenylacetylene, diphenyl imidazole, diphenylfulvene, 1,4-diphenyl-1,3-butadiene, 1,6-diphenyl-1,3,5-hexatriene, dicinnamalacetone, phenylindenone. The co-agent can alternatively be a furan derivative such as 2-vinylfuran. A preferred co-agent is styrene.

The co-agent which inhibits polymer degradation can alternatively be a compound containing an olefinic —C═C— or acetylenic —C═C— conjugated with an olefinic —C═C— or acetylenic —C═C— unsaturated bond. For example a sorbate ester, or a 2,4-pentadienoates, or a cyclic derivative thereof. A preferred co agent is ethyl sorbate of the formula:

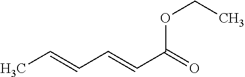

Typically in the case of silane (1) the co-agent is used but in the case of unsaturated silane (2) it is optional.

The temperature at which the polypropylene and silane (1) and/or unsaturated silane (2) silane are reacted in the presence of the compound capable of generating free radical sites in the polypropylene is generally above 120° C., usually above 140° C., and is sufficiently high to melt the polypropylene and to decompose the free radical initiator. For polypropylene, a temperature in the range 170° C. to 220° C. is usually preferred. The peroxide or other compound capable of generating free radical sites in the polypropylene preferably has a decomposition temperature in a range between 120-220° C., most preferably between 160-190° C.

The grafting reaction between the polypropylene and the unsaturated silane can be carried out as a batch process or as a continuous process using any suitable apparatus.

The polypropylene may for example be added in pellet or powder form or a mixture thereof. The polypropylene is preferably subjected to mechanical working while it is heated. A batch process can for example be carried out in an internal mixer such as a Brabender Plastograph (Trade Mark) 350S mixer equipped with roller blades, or a Banbury mixer. A roll mill can be used for either batch or continuous processing. In a batch process, the polypropylene, the unsaturated silane and the compound capable of generating free radical sites in the polypropylene are generally mixed together at a temperature above the melting point of the polypropylene for at least 1 minute and can be mixed for up to 30 minutes, although the time of mixing at high temperature is generally 3 to 15 minutes. Silane (1) or unsaturated silane (2) and the peroxide can be added sequentially although it is preferred to add the peroxide together with the silane. The high temperature mixing is carried out at a temperature which is between the melt temperature and the degradation temperature of the polypropylene used, which is generally above 120° C. For polypropylene the mixing temperature is preferably above 170° C. The reaction mixture can be held at a temperature above 140° C. for a further period of for example 1 to 20 minutes after mixing to allow the grafting reaction to continue.

Continuous processing is generally preferred, and the preferred vessel is an extruder adapted to mechanically work, that is to knead or compound, the materials passing through it, for example a twin screw extruder. One example of a suitable extruder is sold under the trade mark ZSK from Coperion Werner Pfleiderer GmbH & Co KG.

The extruder preferably includes a vacuum port shortly before the extrusion die to remove any unreacted silane. The residence time of the polypropylene, the unsaturated silane and the compound capable of generating free radical sites in the polypropylene together at above 120° C. in the extruder or other continuous reactor is generally at least 0.5 minutes and preferably at least 1 minute and can be up to 15 minutes. More preferably the residence time is 1 to 5 minutes. All or part of the polypropylene may be premixed with the unsaturated silane and/or the compound capable of generating free radical sites in the polypropylene before being fed to the extruder, but such premixing is generally at below 120° C., for example at ambient temperature.

A polyamide blend as hereinbefore described may be prepared in any suitable way. In one embodiment there is provided a method of preparing a polyamide blend as hereinbefore described wherein the polyamide, hydrolysable silane grafted polypropylene and optionally glass based reinforcing filler are first mixed in a dry form and then blended using an extruder or other melt blending equipment. Alternatively there is provided a process for making a polyamide blend wherein the polyamide and hydrolysable silane grafted polypropylene are first mixed in a dry form and then introduced into an extruder or other melt blending equipment with the glass based reinforcing filler being introduced in to the extruder or other melt blending equipment subsequent to the other two ingredients. Alternatively there is provided a still further process for making a polyamide blend in accordance with any preceding claim wherein the polyamide and hydrolysable silane grafted polypropylene are simultaneously or individually introduced into an extruder or other melt blending equipment and are mixed in the extruder or other melt blending equipment prior to the introduction of the glass based reinforcing filler being introduced. It is preferred to introduce the glass based reinforcing filler into the extruder or other melt blending equipment subsequent to the other two ingredients in order to minimise breaks in the glass based reinforcing filler whilst ensuring good homogeneity of the filler in the blend. Any suitable extruder or other melt blending equipment may be utilized an example is as hereinbefore described is that sold under the trade mark ZSK from Coperion Werner Pfleiderer GmbH & Co KG or a Brabender® DSE 20/40 co-rotating twin screw extruder.

The polyamide blend may comprise:
from 1 wt. % to 98 wt. % of a polyamide polymer (1),
from 1 wt. % to 50 wt. % of glass based reinforcing filler (2), and
from 1 wt. % to 98 wt. % of hydrolysable silane grafted polypropylene (3),
   with the total weight % of all ingredients adding up to 100%.

Alternatively, the polyamide blend may comprise:
from 25 wt. % to 75 wt. % of a polyamide polymer (1),
from 15 wt. % to 40 wt. % of glass based reinforcing filler (2), and
from 5 wt. % to 35 wt. % of hydrolysable silane grafted polypropylene (3),
   with the total weight % of all ingredients adding up to 100%.

In a still further embodiment there is provided the use of a hydrolysable silane grafted polypropylene as hereinbefore described in a polyamide blend otherwise comprising a polyamide polymer and a glass based reinforcing filler. In one embodiment thereof the hydrolysable silane grafted polypropylene is a reaction product of a hydrolysable silane as hereinbefore described with a polypropylene as hereinbefore described in the presence of a means for generating free radical sites in the polypropylene as hereinbefore described. In the above use when the hydrolysable silane grafted polypropylene is the aforementioned reaction product, the hydrolysable silane is selected from:
silane (1), having at least one hydrolysable group bonded to Si, or a hydrolysate thereof, and which has the formula R″—CH═CH—Z (I) or R″—C≡C—Z (II) in which Z represents an electron-withdrawing moiety substituted by a —SiRa₃R′₃₋ₐ group wherein R represents a hydrolysable group; R′ represents a hydrocarbyl group having 1 to 6 carbon atoms; a has a value in the range 1 to 3 inclusive; and R″ represents hydrogen or a group having an electron withdrawing effect or any other activation effect with respect to the —CH═CH— or —C≡C— bond, or
unsaturated silane (2), containing an olefinic —C═C— bond or acetylenic —C≡C— bond and having at least one hydrolysable group bonded to Si, which silane contains an aromatic ring or a further olefinic double bond or acetylenic unsaturation, the aromatic ring or the further olefinic double bond or acetylenic unsaturation being conjugated with the olefinic —C═C— or acetylenic —C≡C— unsaturation of the silane.

It was identified that incorporation of hydrolysable silane grafted polypropylene as hereinbefore described in the polyamide resulted in improvements in each of the following:
(i) the processing, compounding and/or injectability of the polyamide blend into an extruder or other melt blending equipment;
(ii) the resistance to water of the polyamide blend;
(iii) the mechanical resistance after water or water/glycol mixture is added to a moulded polyamide blend as hereinbefore described and
(iv) the Heat Distortion Temperature of the polyamide blend (i.e. the temperature at which a moulded polyamide blend as hereinbefore described deforms under a specified load.

The polyamide blend as hereinbefore described may be used for any application suited to a glass fibre filled polyamide blend such as in appliances, consumer products, electronics, machine components, automotive parts.

Examples include replacements for metal parts, for instance in car engine components. Intake manifolds in nylon are tough, corrosion resistant, lighter and cheaper than aluminium (once tooling costs are covered) and offer better air flow due to a smooth internal bore instead of a rough cast one. Its self-lubricating properties make it useful for gears and bearings. Electrical insulation, corrosion resistance and toughness make nylon a good choice for high load parts in electrical applications as insulators, switch housings and the ubiquitous cable ties. Another major application is for power tool housings. door handles & radiator grills: low voltage switch gears, miniature circuit breakers, residual current devices, fuses, switches and relays, contactors and cabinets. As an integral part of the vehicle's body the door handles have many difficult requirements. They must have excellent surface appearance, paintability and UV resistance, but also good mechanical properties like stiffness and toughness.

The invention will now be described by way of Example. All % values are weight % unless otherwise indicated:

### EXAMPLES

The following ingredients were utilized in the examples:
The polypropylene used was Total® PPh9040 from Total, a nucleated polypropylene homopolymer having a melt flow index (MFI) of 25 g/10 min at 230° C./2.16 kg measured in accordance with ISO 1133-1:2011
The polypropylene was grafted using a grafting composition consisting of
   90 wt. % Sorbyloxypropyl trimethoxy silane and
   10 wt. % 2,5-Bis(tert-butyl peroxy)-2,5-dimethylhexane.
      For the avoidance of doubt a hydrolysable silane grafted polypropylene (HSgPP) made with a 1% grafting composition means that 99% weight of polypropylene was mixed with 1% by weight of grafting composition to prepare the HSgPP and a hydrolysable silane grafted polypropylene made with a 3% by weight of grafting composition means that 97% weight of polypropylene was mixed with 3% by weight of grafting composition to prepare the HSgPP.
The resulting grafted polypropylene was added to the following polyamide; ULTRAMID® B27 E01 which is a nylon 6 (PA 6) having a melt flow index (MFI) of 130 g/10 min at 275° C./5 kg measured in accordance with ISO 1133-1:2011;
The polyamide was reinforced with DS 1140-10N type glass fibres
The maleic anhydride grafted polypropylene (MAgPP) utilised in the benchmark examples was Exxelor® P01015 (the maleic anhydride level is typically is understood to be in the range of 0.25 to 0.50 wt. %) having a melt flow index (MFI) of 150 g/10 min at 230° C./2.16 kg measured in accordance with ISO 1133-1:2011.

Whilst in Table 3 below 11.4% by weight of the Benchmark composition was MAgPP, elsewhere unless otherwise identified the amount of MAgPP present was 10% by weight of the composition. Some examples were carried out using 20% by weight of glass fibres but most used 30% glass fibres in the polyamide blend. It should be understood that wherever 30% by weight of glass fibres are used this is the same for the Ref. and Benchmark comparative examples.

### Example 1

### Preparation of Wafted Polypropylene (PP)

A hydrolysable silane grafted polypropylene was prepared in a continuous process using a Brabender® DSE 20/40 co-rotating twin screw extruder having screw diameter of 20 mm and L/D=40. The screws had a rotation speed of 250 rpm, the throughput was 3 kg per hour, the die size was 4 mm and the temperature profile of the 6 heating zones was as follows:
T1=190° C.;
T2=210° C.;
T3=210° C.;
T4=210° C.;
T5=210° C.;
T6=210° C.

The polypropylene (97% by weight of the starting ingredients) was introduced at feeding port OD (diameter) and the grafting composition (3% by weight of the starting ingredients) was then added (as a liquid) at feeding port 10D. The resulting hydrolysable silane grafted polypropylene product was provided in pellet form.

### Example 2

### Preparation of a Polyamide Blend of Polyamide, Glass Fibres and Hydrolysable Silane Grafted Polypropylene

Polyamide pellets were dried for a minimum of 3 hours at 80° C. to ensure they were not containing moisture or to minimise the moisture content. Pellets produced using the process disclosed in Example 1 were initially mixed with pellets of polyamide for a period of 5 minutes in a plastic drum in the desired ratio of ingredients to ensure good mixing prior to introduction on to the aforementioned Brabender® DSE 20/40 co-rotating twin screw extruder as previously described. In this instance, the screws again had a rotation speed of 250 rpm, but the throughput was 2.5 kg per hour and the temperature profile of the 6 heating zones was as follows:
T1=230° C.;
T2=250° C.;
T3=250° C.;
T4=250° C.;
T5=250° C.;
T6=240° C.

The mixture of polyamide pellets and hydrolysable silane grafted polypropylene pellets was introduced at feeding port 0D in the required amounts and glass fibres were introduced at feeding port 20D to ensure homogeneity in the final products but to minimise breakages of the fibres during the extruding process. The resulting polyamide blend was again collected in pellet form.

### Example 3

### Processing Results Based on Example 2

During the above compounding process, values of melt temperature, pressure and torque were noted and are depicted in Table 3. The processing torque is the measure of the torque in Newton*meter (N·m) applied by the motor of the extruder to maintain the rotation speed of 250 rpm. The value reported is the variation of the torque level at the end of the mixing. The lower the torque, the lower the polymer viscosity.

In Table 3 the hydrolysable silane grafted polypropylene is referred to as HSgPP and the maleic anhydride grafted polypropylene used in the benchmark (comparative) example is referred to as MAgPP.

The samples were compared to a Reference material (“Ref.”) which did not contain any grafted polypropylene of any sort and the Benchmark material which contained maleic anhydride grafted polypropylene (MAgPP) which is used within the industry (“Benchmark”).

TABLE 3

| | | Bench- | Sample | Sample | Sample |
|---|---|---|---|---|---|
| | Ref. | mark | 1 | 2 | 3 |
| Polyamide (wt. %) | 80 | 68.6 | 77.7 | 74.3 | 68.6 |
| HSgPP (wt. %) | | | 2.3 | 5.7 | 11.4 |
| Glass fibres (wt. %) | 20 | 20 | 20 | 20 | 20 |
| MAgPP (wt. %) | | 11.4 | | | |
| Tₘₑₗₜ (° C.) | 250 | 269 | 263 | 264 | 264 |
| Pressure (Nm⁻²) | 0.9 × | 0.9 × | 1.0 × | 0.8 × | 0.9 × |
| | 10⁵ | 10⁵ | 10⁵ | 10⁵ | 10⁵ |
| Torque (N · m) | 36 to | 36 to | 31 to | 26 to | 23 to |
| | 37 | 37 | 33 | 28 | 25 |

As can be seen from Table 3 the torque values show a significant reduction when using hydrolysable silane grafted polypropylene, even at lower levels (e.g., Sample 1) compared to the Ref material and Benchmark material. This indicates that the blend as hereinbefore described is significantly more energy efficient than either blend used in the Ref or Benchmark comparatives. It is also to be noted that there was no significant difference in pressure or melt temperature levels.

### Example 4

### Processing Torque Values

Example 4 compares the processing torque values for polyamide blends when using hydrolysable silane grafted polypropylene samples prepared (as described above) but using two different dosing levels of grafting composition (1% and 3%). The Samples were prepared in exactly the same manner as Example 2 with only the dosing levels of the constituents different as indicated. In this example 30% by weight of glass fibre was present.

For the avoidance of doubt a column header stating “5% HSgPP” indicates that the blend consists of:
5% hydrolysable silane grafted polypropylene
30% glass fibre and
65% polyamide;
   and a column header stating “10% HSgPP” indicates that the blend consists of:
10% hydrolysable silane grafted polypropylene
30% glass fibre and
60% polyamide;

In each instance when the amount of HSgPP present increases as shown in the column headers in Table 4a the amount of polyamide changes by the same amount with the total composition always adding up to 100%.

Table 4a(i): The impact on processing torque values caused by changing the comparative amounts of hydrolysable silane grafted polypropylene (HSgPP) and polyamide in a polyamide blend. The HSgPP used was made with a 1% grafting silane composition.

TABLE 4a(i)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| Processing | 42.5 | 41.5 | 31.5 | 26.0 | 22.0 | 22.0 | 20.0 |
| Torque | | | | | | | |
| Value (N · m) | | | | | | | |

Table 4a(ii): The impact on processing torque values caused by changing the comparative amounts of hydrolysable silane grafted polypropylene (HSgPP) and polyamide in a polyamide blend. The HSgPP used was made with a 3% grafting silane composition.

TABLE 4a(ii)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| Processing | 42.5 | 41.5 | 31.6 | 27.0 | 22.0 | 20.5 | 18.5 |
| Torque | | | | | | | |
| Value (N · m) | | | | | | | |

Even though some slight increases have been observed on melt temperature, it is very likely not the reason to have caused the torque to reduce as much as is seen. This torque reduction could be of high interest for polyamide compounders, potentially allowing for higher throughputs or higher glass fibre filling.

### Example 5

### Injection Molding of Samples

Pellets of the polyamide blends prepared in Example 4 were injection moulded using an Engel° VC 200/80 injection press at 280° C. temperature after samples were dried for a minimum of 3 hrs at 80° C. to remove moisture in accordance with recommendations from the polyamide supplier. All compositions contained 30% by weight of glass fibre. Type 1A moulded dumbbells were prepared following the norm NBN EN ISO 527-1: 2012. The resulting dumbbells were removed from their moulds and stored in plastic bags inside a dry cabinet located in temperature controlled area (20° C.) which had a relative humidity level of below 25%.

The modulus of elasticity (henceforth referred to as Emod) of the thus moulded samples was determined using a Zwick & Roell 1445 Universal Testing System following NBN EN ISO527-2: 2012. The results are shown in Table 5a (i) and (ii) below.

Table 5a(i): The impact on E_{mod} ratio values caused by changing the comparative amounts of hydrolysable silane grafted polypropylene (HSgPP) and polyamide in a polyamide blend. The HSgPP used was made with a 1% grafting silane composition.

TABLE 5a(i)

| | | | 5% | 10% | 15% | 20% | 30% |
|---|---|---|---|---|---|---|---|
| | Ref. | Benchmark | HSgPP | HSgPP, | HSgPP, | HSgPP | HSgPP |
| E mod (MPa) | 8826 | 8900 | 9458 | 9500 | 9881 | 9554 | 9030 |

Table 5a(ii): The impact on E_{mod} ratio values caused by changing the comparative amounts of hydrolysable silane grafted polypropylene (HSgPP) and polyamide in a polyamide blend. The HSgPP used was made with a 3% grafting silane composition

TABLE 5a(ii)

| | | | 5% | 10% | 15% | 20% | 30% |
|---|---|---|---|---|---|---|---|
| | Ref. | Benchmark | HSgPP | HSgPP, | HSgPP, | HSgPP | HSgPP |
| E mod (MPa) | 8826 | 8900 | 9614 | 9920 | 10238 | 9836 | 9354 |

The introduction of hydrolysable silane grafted polypropylene into the polyamide blend appears to cause an increase of E_{mod} compared to the Ref. and Benchmark results over a wide range of HSgPP (up to 30% by weight) irrespective of whether said hydrolysable silane grafted polypropylene was made using 1% by weight or 3% by weight of grafting composition (by the method in Example 1).

### Example 6

### Water Uptake After 24 Hrs Aging at 20° C.

Dumbbells prepared as described in Example 5 above were weighed and then immersed in water for 24 hours at 20° C. in a controlled temperature area. Each sample contained 30% by weight of glass fibres. At the end of the immersion period the dumbbells were dried and re-weighed and the results thereof are depicted in Tables 6a (i) and (ii) below with the difference between the initial values and those determined after 24 hours are provided as a percentage:

Table 6a (i): Weight gain of poly amide blends after immersion for 24 h in water at 20° C. water wherein the comparative amounts of hydrolysable silane grafted polypropylene (HSgPP) and polyamide in the polyamide were varied blend. The HSgPP used was made with a 1% grafting silane composition.

TABLE 6a(i)

| | | Bench- | 5% | 10% | 15% | 20% | 30% |
|---|---|---|---|---|---|---|---|
| | Ref. | mark | HSgPP | HSgPP | HSgPP | HSgPP | HSgPP |
| Weight | 0.97 | 0.74 | 0.78 | 0.72 | 0.6 | 0.45 | 0.28 |
| Water | | | | | | | |
| Uptake (%) | | | | | | | |

Table 6a(ii): Weight gain of poly amide blends after immersion for 24 h in water at 20° C. water wherein the comparative amounts of hydrolysable silane grafted polypropylene (HSgPP) and polyamide in the polyamide were varied blend. The HSgPP used was made with a 3% grafting silane composition.

TABLE 6a(ii)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| Weight | 0.97 | 0.74 | 0.86 | 0.79 | 0.65 | 0.43 | 0.33 |
| Water | | | | | | | |
| Uptake (%) | | | | | | | |

It should be noted that water uptake decreased significantly as the proportion of hydrolysable silane grafted polypropylene increased and the proportion of polyamide reduced.

### Example 6b

Samples containing 20% by weight of glass fibre were prepared in the same manner as the samples in 6a and were then dried. The resulting dried samples were then analysed for their tensile properties after aging in water for 24 hours at 20° C. Table 6b provides the modulus of elasticity (E_{mod}) and maximal tensile stress (MTS). The values for Maximal tensile stress (MTS) were determined using a Zwick & Roell 1445 Universal Testing System following NBN EN IS0527-2. Samples tested were the Ref. (containing merely 20% by weight glass fibres and 80% by weight polyamide), the benchmark using two levels of maleic anhydride grafted polypropylene (comparatives) and 2 samples using 5 and 10% HSgPP.

Table6b: Comparison of Tensile Properties of Samples containing20% by weight glass fibres and MAgPP (comparative) or HSgPP with Ref. after aging by immersion in water for 24 hours at 20° C. The HSgPP material had been made using a 3% grafting composition

TABLE 6b

| | Ref. | Ref | 5% MAgPP | 10% MAgPP | 5% | 10% |
|---|---|---|---|---|---|---|
| | (non- aged) | (aged) | Benchmark | Benchmark | HSgPP | HSgPP |
| E_{mod} | 6500 | 6248 | 6233 | 5835 | 6616 | 7110 |
| | | | (−0.24%) | (−6.6%) | (+5.9%) | (+13.8%) |
| MTS | 136.7 | 120.2 | 123.1 | 114.6 | 126.1 | 127.6 |
| | | | (+2.4%) | (+4.7%) | (+4.9%) | (+6.2%) |

The % results in the above indicate the % difference of the Benchmark comparative results and the HSgPP results when compared to the aged Ref. results. It will be appreciated that the HSgPP samples provided the best results.

### Example 6c

The E_{Mod} values were also determined with compositions containing 30% by weight of glass fibres and varying amounts of MAgPP (comparative Benchmark) and HSgPP again after aging in water for 24 hours at 20° C. using HSgPP made using 1% or 3% grafting compositions. The results are depicted in Tables 6c (i) and (ii).

Table 6c(i): Comparison of E_{Mod} Properties of Samples containing 30% by weight glass fibres and MAgPP (comparative) or HSgPP with Ref. after immersion in water for 24 hours at 20° C. The HSgPP material had been made using a 1% grafting composition.

TABLE 6c(i)

| | | | 5% | 10% | 15% | 20% | 30% |
|---|---|---|---|---|---|---|---|
| | PA ref. | Benchmark | HSgPP | HSgPP | HSgPP | HSgPP | HSgPP |
| E mod (MPa) | 8404 | 8097 | 8030 | 8320 | 8444 | 8377 | 8237 |

Table 6c(ii): Comparison of E_{Mod} Properties of Samples containing 30% by weight glass fibres and MAgPP (comparative) or HSgPP with Ref. after immersion in water for 24 hours at 20° C. The hours at 20° C. The HSgPP material had been made using a 3% grafting composition.

TABLE 6c(ii)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| E mod (MPa) | 8404 | 8097 | 8389 | 8636 | 8931 | 8731 | 8692 |

Trends on initial properties were observed after water uptake. Polyamide blends containing HSgPP made with a 3% grafting composition (Table 6c(ii)) have higher modulus of elasticity values than polyamide blends containing HSgPP made with a 1% grafting composition (Table 6c(i)).

### Example 6d

Impact properties of aged dumbbells (24 hours immersion in water at 20° C.) and subsequently dried as described in Example 6a above were tested to determine non-instrumental resilience in accordance with norm ISO 179-1:2010 using a Ceast® Resil Impactor and the results are depicted in Table 6d below.

Table 6d: Non-instrumental resilience of dried dumbbells after aging in water for 24 hours at 20° C. The dried dumbbells were made from polyamide blends containing 20% by weight glass fibres and varying amounts of MAgPP (comparative) or HSgPP. The HSgPP material had been made using a 3% grafting composition.

TABLE 6d

| | non-aged | Aged | 10% | 5% | 2% | 10% | 5% | 2% |
|---|---|---|---|---|---|---|---|---|
| | Ref. | Ref. | MAgPP | MAgPP | MAgPP | HSgPP | HSgPP | HSgPP |
| Non- | 50.7 | 43.5 | 82.0 | 78.1 | 49.9 | 74.0 | 77.9 | 64.2 |
| Instrumental | | | | | | | | |
| Resilience | | | | | | | | |
| (kJ/m²) | | | | | | | | |

These results showed significant improvements over the aged Ref. and non-aged Ref. polyamide blends containing no grafted polypropylene. The results for polyamide blends containing maleic anhydride grafted polypropylene (MAgPP)(comparatives) and hydrolysable silane grafted polypropylene (HSgPP) were about equivalent when the same levels of each type of grafted polypropylene were compared.

### Example 7

This example studies the effect of immersing dumbbell samples in a water:ethylene glycol 1:1 mixture for 5 days at a temperature of 95° C.

Dumbbells prepared as described in Example 5 above were weighed and then immersed in a 1:1 by weight mixture of water and ethylene glycol for 5 days at a temperature of 95° C. in a controlled temperature area. At the end of the immersion period the dumbbells were dried and re-weighed and the results thereof are depicted in Table 7a(i) for HSgPP samples made using a 1% grafting composition and Table 7a(ii) for HSgPP samples made using a 3% grafting composition. The results provided indicate the difference between the initial values and those determined after 5 days at a temperature of 95° C. are provided as a percentage:

Table 7a(i): Water uptake after immersion of dumbbell samples in a 1:1 by weight mixture of water and ethylene glycol for 5 days at a temperature of 95° C. The samples contained 30% glass fibres and the HSgPP used was made using a 1% grafting composition

TABLE 7a(i)

| | PA | | 5% | 10% | 15% | 20% | 30% |
|---|---|---|---|---|---|---|---|
| | ref. | Benchmark | HSgPP | HSgPP | HSgPP | HSgPP | HSgPP |
| Weight | 7.94 | 6.93 | 7.53 | 7 | 6.55 | 5.74 | 3.84 |
| Water | | | | | | | |
| Uptake (%) | | | | | | | |

Table 7a(ii): Water uptake after immersion of dumbbell samples in a 1:1 by weight mixture of water and ethylene glycol for 5 days at a temperature of 95° C. The samples contained 30% glass fibre and the HSgPP used was made using a 3% grafting composition

TABLE 7a(ii)

| | PA | | 5% | 10% | 15% | 20% | 30% |
|---|---|---|---|---|---|---|---|
| | ref. | Benchmark | HSgPP | HSgPP | HSgPP | HSgPP | HSgPP |
| Weight | 7.94 | 6.93 | 7.37 | 6.9 | 6.84 | 5.64 | 3.56 |
| Water | | | | | | | |
| Uptake (%) | | | | | | | |

Again it should be noted that water uptake decreased significantly as an increasing proportion of hydrolysable silane grafted polypropylene was introduced into the composition and the proportion of polyamide reduced.

### Example 7b

The E_{Mod} properties of dried dumbbells after aging as indicated in Tables 7a(i) and (ii) were then assessed and the results are provided in Tables 7b(i) for HSgPP made with a 1% grafting composition and Tables 7b(ii) for HSgPP made with a 3% grafting composition.

Table 7b(i): E_{Mod} properties after immersion in a 1:1 by weight mixture of water and ethylene glycol for 5 days at a temperature of 95° C. The samples contained 30% glass fibre and the HSgPP used was made using a 1% grafting composition.

TABLE 7b(i)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| E mod (MPa) | 3301 | 3566 | 3940 | 4438 | 4799 | 5080 | 5782 |

Table 7b (ii) E_{Mod} properties after immersion in a 1:1 by weight mixture of water and ethylene glycol for 5 days at a temperature of 95° C. The samples contained 30% glass fibre and the HSgPP used was made using a 3% grafting composition

TABLE 7b(ii)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| E mod (MPa) | 3301 | 3566 | 4144 | 4675 | 5110 | 5527 | 6280 |

The polyamide reference has the lowest E_{mod} value of the series, lower than the benchmark result. It is to be noted that polyamide blends containing hydrolysable silane grafted polypropylene provides significantly higher level of E_{mod} and that the E_{mod} values increase as the level of hydrolysable silane grafted polypropylene in the polyamide blends increases. It would also seem that the level of grafting composition used in the making of the hydrolysable silane grafted polypropylene has an effect with the hydrolysable silane grafted polypropylene made using 3% by weight grafting composition always giving higher E_{mod} results than those made with 1% by weight of grafting composition.

### Example 7c

Table 7c(i): MTS properties after immersion in a 1:1 by weight mixture of water and ethylene glycol for 5 days at a temperature of 95° C. The samples contained 30% glass fibre and the HSgPP used was made using a 1% grafting composition

TABLE 7c(i)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| MTS (MPa) | 85.1 | 87.6 | 89.9 | 91.3 | 87.6 | 84.1 | 78.6 |

Table 7c(ii): MTS properties after immersion in a 1:1 by weight mixture of water and ethylene glycol for 5 days at a temperature of 95° C. The samples contained 30% glass fibre and the HSgPP used was made using a 3% grafting composition

TABLE 7c(ii)

| | | | 5% | 10% | 15% | 20% | 30% |
|---|---|---|---|---|---|---|---|
| | Ref. | Benchmark | HSgPP | HSgPP | HSgPP | HSgPP | HSgPP |
| MTS (MPa) | 85.1 | 87.6 | 90.7 | 95.0 | 96.3 | 89.4 | 73.6 |

For MTS, trends were similar to other initial properties trends. MTS values were slightly higher using 3% silane addition ratio.

### Example 7d

Table 7d: Comparison and variations of E_{mod} and MTS properties after immersion in a 1:1 by weight mixture of water and ethylene glycol for 5 days at a temperature of 95° C. The samples contained 30% glass fibre and the HSgPP used was made using a 3% grafting composition.

TABLE 7d

| | Ref. | Benchmark | 15% HSgPP |
|---|---|---|---|
| E_{mod} (MPa) - initial | 8826 | 8900 (+1%) | 10238 (+16%) |
| E_{mod} (MPa) - after water/ | 3301 | 3566 (+8%) | 5110 (+55%) |
| glycol ageing | | | |
| MTS (MPa) - initial | 171.9 | 152.4 (−13%) | 165.5 (−4%) |
| MTS (MPa) - after water/ | 85.1 | 87.6 (+3%) | 96.3 (+13%) |
| glycol ageing | | | |

### Example 8

### Water/Ethylene Glycol Uptake After 1000 Hrs at 130° C. in a 1:1 by Weight Mixture of Water and Ethylene Glycol

Dumbbells prepared as described in Example 5 above were weighed and then immersed in a 1:1 by weight mixture of water and ethylene glycol for 1000 hrs at 130° C. in a controlled temperature area. At the end of the immersion period the dumbbells were dried and re-weighed and the results thereof are depicted in Table 8a below with the difference between the initial values and those determined after 1000 hrs at 130° C. being provided as a percentage in Table 8a below:

Table 8a: Water/glycol uptake after 1000 hrs @ 130° C. immersion The samples contained 30% glass fibre. The HSgPP(a) samples were made using a 1% grafting composition and the HSgPP(b) samples were made using a 3% grafting composition

TABLE 8a

| | | | 10% | 15% | 10% | 15% |
|---|---|---|---|---|---|---|
| | Ref. | Benchmark | HSgPP(a) | HSgPP(a) | HSgPP(b) | HSgPP(b) |
| Weight | 13.34 | 12.09 | 11.85 | 10.84 | 11.2 | 10.38 |
| Water | | | | | | |
| Uptake (%) | | | | | | |

Again it should be noted that water uptake decreased significantly as an increasing proportion of hydrolysable silane grafted polypropylene increased and the proportion of polyamide reduced. The absorption was decreased down to 78% of that of the Ref.

Table 8b: E_{mod} and MTS properties after 1000 hrs at 130° C. in a 1:1 by weight mixture of water and ethylene glycol. The samples contained 30% glass fibre. The HSgPP(a) samples were made using a 1% grafting composition and the HSgPP(b) samples were made using a 3% grafting composition.

TABLE 8b

| | | | 10% | 15% | 10% | 15% |
|---|---|---|---|---|---|---|
| | Ref. | BENCHMARK | HSgPP(a) | HSgPP(a) | HSgPP(a) | HSgPP(a) |
| Emod | 2389 | 2500 | 3269 | 3756 | 3568 | 4025 |
| (MPa) | | | | | | |
| MTS | 11.1 | 12.6 | 15.0 | 17.0 | 16.6 | 20.0 |
| (MPa) | | | | | | |

At the toughest exposure during longest time and highest temperature the silane grafted PP addition has proven the best resistance in regards of both Emod and MTS evaluated.

Table 8c(i): E_{mod} and MTS comparison with Ref. The samples contained 30% glass fibre. The HSgPP(a) samples were made using a 1% grafting composition and the HSgPP(b) samples were made using a 3% grafting composition

TABLE 8c(i)

| | E_{Mod} (MPa) | MTS (MPa) |
|---|---|---|
| Benchmark | 4.7% | 13.5% |
| 10% HSgPP(a) | 36.8% | 35.1% |
| 15% HSgPP(a) | 36.6% | 53.2% |
| 10% HSgPP(b) | 49.4% | 49.6% |
| 15% HSgPP(b) | 68.5% | 80.2% |

Table 8c(ii): E_{mod} and MTS comparison with Benchmark results in Table 9b. The samples contained 30% glass fibre. The HSgPP(a) samples were made using a 1% grafting composition and the HSgPP(b) samples were made using a 3% grafting composition

TABLE 8c(ii)

| | E_{Mod} (MPa) | MTS (MPa) |
|---|---|---|
| 10% HSgPP(a) | 30.8% | 19.1% |
| 15% HSgPP(a) | 50.2% | 34.9% |
| 10% HSgPP(b) | 43.5% | 31.8% |
| 15% HSgPP(b) | 61.0% | 58.7% |

The results after 1000 hrs/130° C. in water/glycol ageing were significantly improved not only compared to reference 30% GF/filled material, but also compared with the maleic anhydride grafted polypropylene samples by up to almost 70% depending on the level of addition of hydrolysable silane grafted polypropylene.

### Example 9

### Heat Deflection Temperature (HDT) Performance

HDT measurements were made using a Metravib® 0.1 dB Visco Analyser DMA50 by 3 points bending measurements accessory following ISO 75-2:2004 norm method A (1.8 MPa) and method B (0.45 MPa). Temperatures are reported at 0.1% and 0.2% deflection. Results are provided in Tables 9a (i) and (ii) for the Method B results and Tables 9a (iii) and (iv).

Table 9a (i) HDT properties following ISO 75-2:2004 norm method B with a low load of 0.45 MPa. The samples contained 30% glass fibre and the HSgPP used was made using a 1% grafting composition

TABLE 9a (i)

| | Strain 0.1% (112 μm) | Strain 0.2% (225 μm) |
|---|---|---|
| Sample | ISO75-2: 2004 Method B | ISO75-2: 2004 Method B |
| Ref | 208.8 | 219.6 |
| Benchmark | 206.6 | 216.6 |
| 5% HSgPP | 210.9 | 219.6 |
| 10% HSgPP | 211.4 | 218.8 |
| 15% HSgPP | 215.8 | 221.3 |
| 20% HSgPP | 211.9 | 218.5 |
| 30% HSgPP | 204.2 | 213.3 |

Table 9a(ii) HDT properties following ISO 75-2:2004 norm method B with a low load of 0.45 MPa. The samples contained 30% glass fibre and the HSgPP used was made using a 3% grafting composition.

TABLE 9a (ii)

| | Strain 0.1% (112 μm) | Strain 0.2% (225 μm) |
|---|---|---|
| Sample | ISO75-2: 2004 Method B | ISO75-2: 2004 Method B |
| Ref | 208.8 | 219.6 |
| PA/MAgPP | 206.6 | 216.6 |
| Benchmark | | |
| 5% HSgPP | 213.1 | 220.1 |
| 10% HSgPP | 214.6 | 219.4 |
| 15% HSgPP | 213.7 | 219.2 |
| 20% HSgPP | 215.3 | 220.6 |
| 30% HSgPP | 200.4 | 209.8 |

Table 9a (iii) HDT properties HDT properties following ISO 75-2:2004 norm method A with a high load of 1.8 MPa. The samples contained 30% glass fibre and the HSgPP used was made using a 1% grafting composition.

TABLE 9a (iii)

| | Strain 0.1% (112 μm) | Strain 0.2% (225 μm) |
|---|---|---|
| Sample | ISO75-2: 2004 Method A | ISO75-2: 2004 Method A |
| Ref. | 183.2 | 200.5 |
| Benchmark | 187.8 | 201.1 |
| 5% HSgPP | 195.7 | 205.4 |
| 10% HSgPP | 198.0 | 206.0 |
| 15% HSgPP | 198.4 | 207.1 |
| 20% HSgPP | 190.4 | 202.6 |
| 30% HSgPP | 176.6 | 194.0 |

Table 9a (iv) HDT properties HDT properties following ISO 75-2:2004 norm method A with a high load of 1.8 MPa. The samples contained 30% glass fibre and the HSgPP used was made using a 3% grafting composition.

TABLE 9a (iv)

| | Strain 0.1% (112 μm) | Strain 0.2% (225 μm) |
|---|---|---|
| Sample | IS075-2: 2004 Method A | ISO75-2: 2004 Method A |
| Ref | 183.2 | 200.5 |
| Benchmark | 187.8 | 201.1 |
| 5% HSgPP | 189.6 | 204.1 |
| 10% HSgPP | 195.3 | 205.7 |
| 15% HSgPP | 199.9 | 208.0 |
| 20% HSgPP | 190.8 | 205.3 |
| 30% HSgPP | 189.6 | 178.6 |

These Heat Deflection temp results on non-aged Ref. results indicated improved HDT performances in polyamide blends containing from 5 to 20 wt. % of hydrolysable silane grafted polypropylene.

1. A polyamide blend having improved resistance to moisture absorption, the polyamide blend comprising:
(1) a polyamide polymer;
(2) a glass based reinforcing filler; and
(3) a hydrolysable silane grafted polypropylene.

2. The polyamide blend in accordance with claim 1, wherein the polyamide polymer comprises nylon.

3. The polyamide blend according to claim 1, wherein the glass based reinforcing filler comprises glass fibers.

4. The polyamide blend in accordance with claim 1, wherein the hydrolysable silane grafted polypropylene is a reaction product of a hydrolysable silane with a polypropylene in the presence of a means for generating free radical sites in the polypropylene.

5. The polyamide blend in accordance with claim 4, wherein the hydrolysable silane is selected from:
a silane having at least one hydrolysable group bonded to Si, or a hydrolysate thereof, and which has the formula R″—CH═CH—Z (I) or R″—C≡C—Z (II) in which Z represents an electron-withdrawing moiety substituted by a —SiRₐR′₃₋ₐ group wherein R represents a hydrolysable group; R′ represents a hydrocarbyl group having 1 to 6 carbon atoms; a has a value in the range 1 to 3 inclusive; and R″ represents hydrogen or a group having an electron withdrawing effect or any other activation effect with respect to the —CH═CH— or —C≡C— bond; or
an unsaturated silane containing an olefinic —C═C— bond or acetylenic —C≡C— bond and having at least one hydrolysable group bonded to Si, which unsaturated silane contains an aromatic ring or a further olefinic double bond or acetylenic unsaturation, the aromatic ring or the further olefinic double bond or acetylenic unsaturation being conjugated with the olefinic —C═C— or acetylenic —C≡C— unsaturation of the unsaturated silane.

6. The polyamide blend in accordance with claim wherein the electron-withdrawing moiety Z is a C(═O)R*, C(═O)OR*, OC(═O)R*, C(═O)Ar or C(═O)—NH—R* moiety in which Ar represents arylene substituted by a —SiRₐR′₍₃₋ₐ₎ group and R* represents a hydrocarbon moiety substituted by a —SiRₐR*₍₃₋ₐ₎ group.

7. The polyamide blend in accordance with claim 1, wherein the unsaturated silane comprises a sorbyloxyalkylsilane.

8. The polyamide blend in accordance with claim 1, comprising:
(1) from 1 wt % to 99 wt % of the polyamide polymer;
(2) from 0.1 wt % to 50 wt % of the glass based reinforcing filler; and
(3) from 1 wt % to 99 wt % of the hydrolysable silane grafted polypropylene;
wherein the total amount of components (1), (2), and (3) is 100 wt %.

9. The polyamide blend in accordance with claim 1, consisting of the polyamide polymer, the glass based reinforcing filler, and the hydrolysable silane grafted polypropylene.

10. A process for making the polyamide blend in accordance with claim 1, wherein the polyamide polymer, the hydrolysable silane grafted polypropylene and optionally the glass based reinforcing filler are first mixed in a dry form and then blended using an extruder or other melt blending equipment.

11. (canceled)

12. (canceled)

13. An article selected from the group consisting of appliances, consumer products, electronics, machine components, and automotive parts, wherein the article includes a polyamide blend and/or a component formed from the polyamide blend, and wherein the polyamide blend is in accordance with claim 1.

14. The article in accordance with claim 13, selected from the group consisting of automotive engine components, intake manifolds, gears and bearings, electrical insulation, switch housings, cable ties, power tool housings, door handles, radiator grills, low voltage switch gears, miniature circuit breakers, residual current devices, fuses, relays, and contactors and/or as an integral part of a vehicle body.

15. A method of forming an article, the method comprising extruding and/or molding the polyamide blend in accordance with claim 1 to form the article; optionally, wherein the article is selected from the group consisting of automotive engine components, intake manifolds, gears and bearings, electrical insulation, switch housings, cable ties, power tool housings, door handles, radiator grills, low voltage switch gears, miniature circuit breakers, residual current devices, fuses, relays, and contactors and/or is an integral part of a vehicle body.

16. The polyamide blend in accordance with claim 1, wherein the polyamide polymer comprises or is nylon 6, nylon 6,6, or a combination thereof.

17. The polyamide blend in accordance with claim 1, wherein the unsaturated silane comprises or is 3-sorbyloxipropyltrimethoxysilane.
